(19) United States
(12) Patent Application Publication
(10) Pub. No.: US 2003/0226460 A1
(43) Pub. Date: Dec. 11, 2003

(54) Image output apparatus having a paper folding line forming function and paper folding line forming method using the same

(75) Inventor: Young-Hye Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/307,398

(22) Filed: Dec. 2, 2002

(30) Foreign Application Priority Data
Jun. 5, 2002 (KR) 2002-31602

(51) Int. Cl. B41F 13/24

(52) U.S. Cl. 101/232

(57) ABSTRACT

An image output apparatus has first and second folding line forming apparatuses to form folding lines on a sheet of paper in longitudinal and latitudinal directions according to an input pattern. Thus, a user can easily fold the paper into a desired shape and the folding lines can be formed both in the longitudinal and latitudinal directions so that a variety of folding line patterns can be realized.

### CROSS-REFERENCE TO RELATED APPLICATIONS

This application claims the benefit of Korean Application No. 2002-31602, filed Jun. 5, 2002, in the Korean Intellectual Property Office, the disclosure of which is incorporated herein by reference.

### BACKGROUND OF THE INVENTION

1. Field of the Invention

The present invention relates to an image output apparatus having a paper folding line forming function and a paper folding line forming method using the same.

2. Description of the Related Art

Image output apparatuses such as printers, copiers or multi-functional apparatuses print a desired image on a feeding paper and output the printed paper along a predetermined paper output path. However, the paper outputted from the image output apparatus is frequently folded several times prior to use. For example, newspapers, cards, or organizational publications such as church bulletins are distributed by being folded vertically or horizontally at the center. In these cases, the paper outputted from the image output apparatus must be manually folded. However, it is not easy to fold the paper accurately. In particular, it is extremely cumbersome to fold many sheets of paper.

Thus, when large amounts of paper must be folded, an image output apparatus having a folding function is needed to reduce the workload.

### SUMMARY OF THE INVENTION

Accordingly, it is an object of the present invention to provide an image output apparatus to form a folding line on an outputted paper and a method of forming a folding line using the above apparatus.

Additional objects and advantages of the invention will be set forth in part in the description which follows and, in part, will be obvious from the description, or may be learned by practice of the invention.

The foregoing and other objects of the present invention are achieved by providing an image output apparatus to print an image on a sheet of paper and to output the printed paper while transferring the paper, the apparatus including a first folding line forming apparatus to form a first folding line in a first direction parallel to a direction in which the paper is transferred along a paper transfer path; and a second folding line forming apparatus to form a second folding line in a second direction perpendicular to the paper transfer direction, wherein the first and second folding line forming apparatuses are provided along the paper transfer path.

The foregoing and other objects of the present invention are also achieved by providing a method of forming a paper folding line of an image output apparatus including providing a first folding line forming apparatus to form a folding line in a first direction parallel to a direction in which a sheet of paper is transferred along a paper transfer path and a second folding line forming apparatus to form a folding line in a second direction perpendicular to the first direction, wherein the first and second folding line forming apparatuses are provided on the paper transfer path; inputting a folding line pattern to be formed on the paper in the first and second directions; and forming the folding lines in the first and second directions by selectively driving the first and second folding line forming apparatuses according to the input folding line pattern.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a view illustrating the structure of an image output apparatus according to an embodiment of the present invention;

FIG. 2 is a perspective view illustrating the first and second folding line forming apparatus of the image output apparatus of FIG. 1;

FIGS. 3 and 4 are views illustrating selection screens provided to a user by an information processor to utilize the image output apparatus of FIG. 1;

FIG. 5 is a view for explaining the forming of a second direction folding line by the second folding line forming apparatus of FIG. 1;

FIG. 6 is a view for explaining the forming of a first direction folding line by the first folding line forming apparatus of FIG. 1; and

FIGS. 7 and 8 are views for explaining another example of use of the first folding line forming apparatus of FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

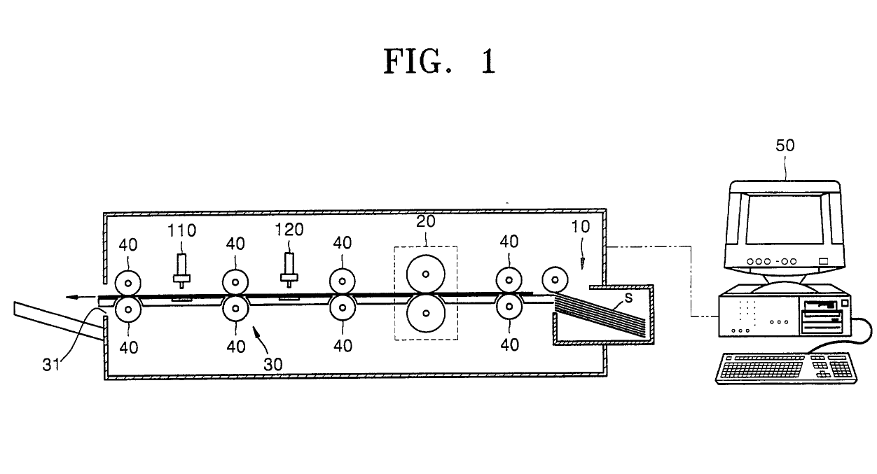

FIG. 1 schematically shows the structure of the inside of an image output apparatus having a folding line forming function according to an embodiment of the present invention.

As shown in FIG. 1, an image output apparatus according to an embodiment of the present invention includes a paper supply portion 10 to supply a sheet of paper, a print portion to print an image on the supplied paper, and a paper exhaust portion 30 to output the printed paper through a paper exhaust outlet 31. Also, there is a first folding line forming apparatus 110 to form a folding line in a longitudinal direction X (hereinafter, referred to as the “first direction”) parallel to a direction in which the paper is transferred. A second folding line forming apparatus 120 forms a folding line in a latitudinal direction (hereinafter, referred to as the “second direction”) perpendicular to the first direction.

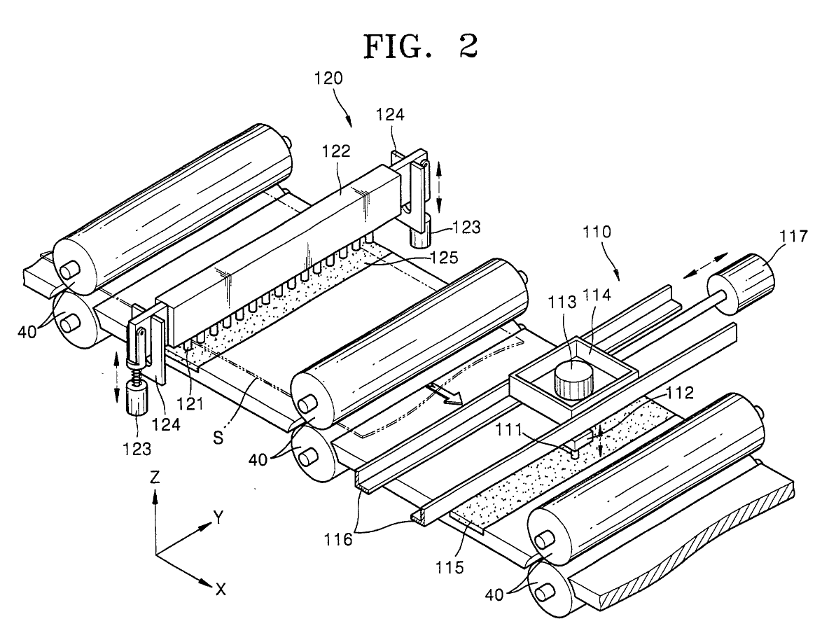

The second folding line forming apparatus 120, as shown in FIG. 2, includes an elevating plate 122 installed at a support body 124 to move up and down, an actuator 123 to drive the elevating plate 122, a pressing pin 121 installed on a lower surface of the elevating plate 122, and a support pad 125 to receive a pressing force of the pressing pin 121 at a opposite side of a paper S. The elevating plate 122 has a width which is the same as a width of the paper S in the second direction. Thus, when the actuator 123 lowers the elevating plate 122 when the paper S is disposed just under the elevating plate 122, the pressing pin 121 presses the paper S against the support pad 125 so that a folding line is made across the entire width of the paper S in the second direction. A rubber pad capable of elastically receiving the pressure from the pressing pin 121 may be used as the support pad 125.

Also, the first folding line forming apparatus 110 includes an elevating member 112 installed to be elevated above a transfer path of the paper S, an actuator 113 to elevate the elevating member 112, and a pressing pin 111 installed at a lower surface of the elevating member 112. Here, unlike the elevating member 112 of the second folding line forming apparatus 120, the elevating member 112 has a width approximately corresponding to an area where a folding line is formed in the first direction, not the entire width across the paper S. That is, the first folding line forming apparatus 110 does not print a folding line across the entire width in the first direction at a time in which the paper S is not moved, but instead the folding line in the first direction is formed by repeating the actions of ascending and descending the elevating member 112 while the paper S is transferred in the first direction.

The elevating member 112 can be transferred by a transfer unit in the second direction. The transfer unit includes a guide rail 116 installed in the second direction, a moving block 114, on which the elevating member 116 and the actuator 113 are mounted, installed to move along the guide rail 116, and a driving apparatus 117 to move the moving block 114 to a desired position along the guide rail 116. Thus, after the driving apparatus 117 moves the moving block 114 to a desired position in the second direction, the elevating member 112 is moved up and down by the actuator 113 so that a folding line in the first direction is formed at the desired position on the paper S.

In the image output apparatus having the above structure, a paper folding line is formed as follows.

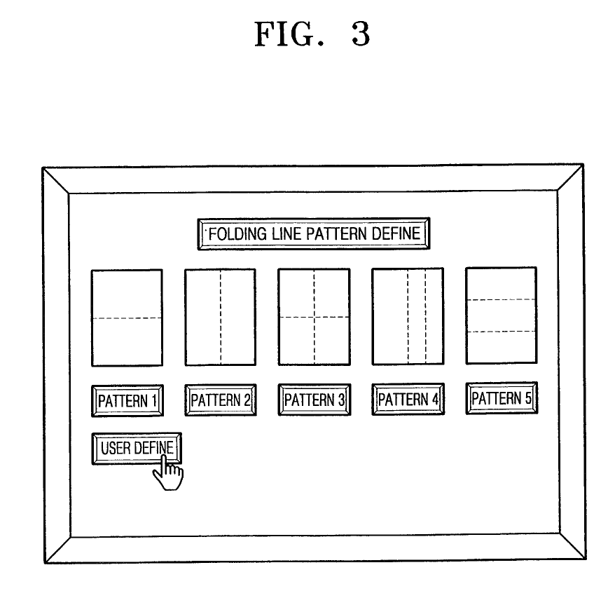

First, a user selects a desired folding pattern through an information processor 50 (please refer to FIG. 1) connected to the image output apparatus. A variety of patterns are provided to the user as shown in FIG. 3. Then, the user selects a desired folding line pattern from among the provided patterns. Here, the user can arbitrarily set the position of a folding line by pressing a button “user define” and receiving a setting environment as shown in FIG. 4, instead of the previously set patterns. Of course, since the arbitrary setting does not exceed a scope of the combination of two folding lines in the first and second directions, the first and second folding line forming apparatuses 110 and 120 can sufficiently cope with the arbitrary setting.

For example, it is assumed that a user selects a pattern in which folding lines are formed in the middle of the longitudinal and latitudinal directions, that is, the third pattern in FIG. 3. In this state, as printing proceeds, the paper S supplied from the paper supply portion 10 proceeds along a transfer path, passes the print portion 20, and arrives at the paper output portion 30 where the first and second folding line forming apparatuses 110 and 120 are installed. Typically, since the folding line is formed together with a print job, in most cases, an image has already been printed on the paper S after passing the print portion 20. However, in some cases, folding lines are to be formed on a non-printed paper. In this case, the paper S arrives at the first and second folding line forming apparatuses 110 and 120 without printing an image thereon at the print portion 20. Here, it is possible to switch the positions of the first and second folding line forming apparatuses 110 and 120. In the present embodiment, the second folding line forming apparatus 120 is arranged ahead of the first folding line forming apparatus 110. Thus, the paper S passing the print portion 20 first meets the second folding line forming apparatus 120.

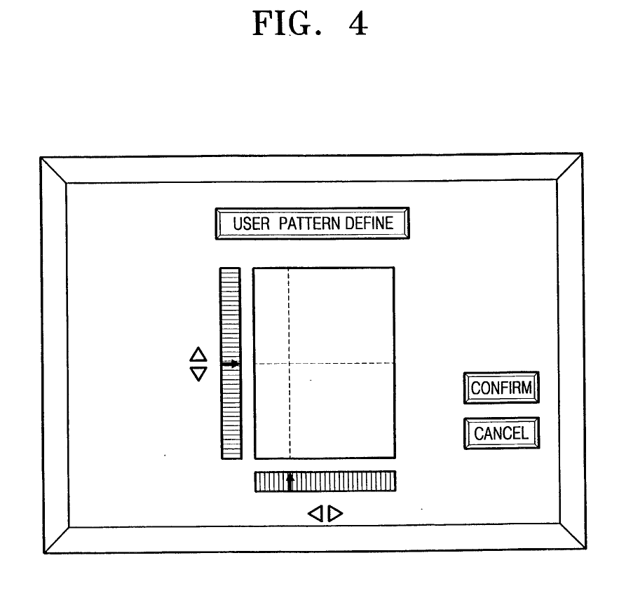

Here, a controller (not shown) of the image output apparatus controls the paper transfer position so that a position where a folding line the second direction is formed is disposed just under the elevating plate 122 of the second folding line forming apparatus 120. That is, when the position where the folding line in the second direction is formed on the paper S is disposed just under the elevating plate 122, the controller stops a transfer roller 40. Next, the elevating plate 122 is lowered by the control of the controller. Then, the pressing pin 121 installed at the elevating plate 122 presses the paper S against the support pad 125, as shown in FIG. 5, so that the folding line is formed across the entire width in the second direction. Thereafter, as the elevating plate 122 ascends, the controller drives the transfer roller 40 again to move the paper S toward the first folding line forming apparatus 110.

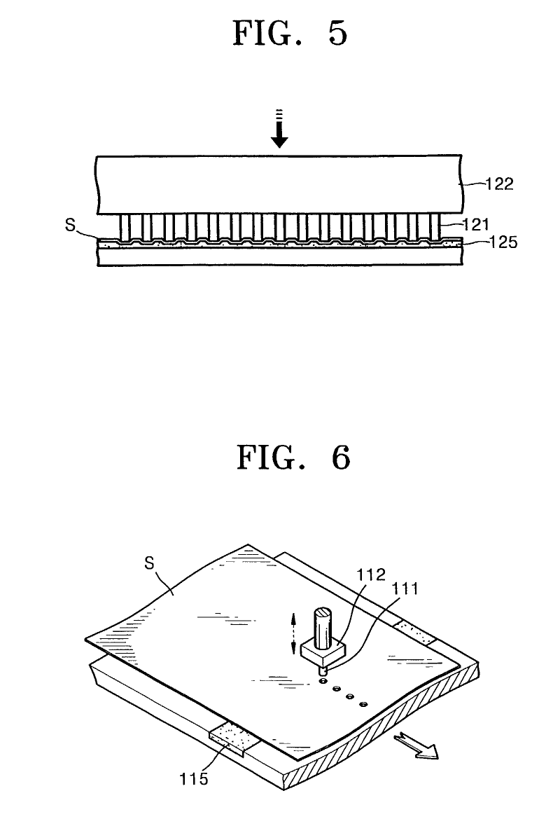

When the paper S is moved toward the first folding line forming apparatus 110, the controller controls the driving apparatus 117 to move the moving block 114 so that the elevating member 112 is disposed just above a position where a folding line is to be formed in the first direction. Next, when the leading end of the paper enters the position just under the elevating member 112, the elevating member 112 is lowered by the actuator 113. Then, the pressing pin 111 installed at the elevating member 112 presses the leading end of the paper S against a support pad 115 formed of rubber to form a folding line. While the paper S is moved in the first direction, as shown in FIG. 6, the folding line in the first direction is formed on the trailing end of the paper by repeating the elevating motion.

By the above operations, folding lines, for example, in the shape of a cross, are formed on the paper S passing the first and second folding line forming apparatuses 110 and 120. Thus, the paper S outputted after passing the above operations can be easily folded into a desired shape by folding along the folding lines.

In the meantime, when two folding lines are to be formed in the second direction, such as in the fifth pattern shown in FIG. 3, the paper S is stopped at a position where the first folding line is to be formed and the elevating plate 122 of the second folding line forming apparatus 120 is lowered to form a folding line. Then, the elevating plate 122 is lifted and the paper S is moved and stopped at a position where the second folding line is to be formed and the above operation is repeated to form the second folding line.

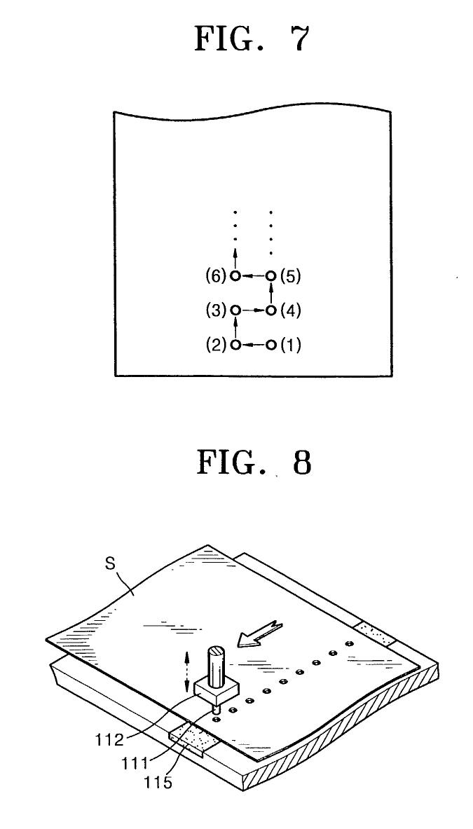

Also, when two folding lines are to be formed in the first direction, such as in the fourth pattern shown in FIG. 3, the elevating member 112 is reciprocated by the transfer unit between the first folding line position and the second folding line position and moved up and down. For example, as shown in FIG. 7, two folding lines in the first direction are formed by changing the position of the elevating member 112 in the order of (1)→(2)→(3)→(4)→(5)→(6). Here, the position changes of (1)→(2), (3)→(4), and (5)→(6) are performed by changing the position of the elevating member 112 along the guide rail 116 by the transfer unit while the position changes of (2)→(3) and (4)→(5) are performed by transfer of the paper S by the transfer roller 40.

In the present embodiment, the first and second folding line forming apparatuses 110 and 120 are separately provided. However, the folding lines in the first and second directions may both be formed only by the first folding line forming apparatus. That is, as shown in FIG. 8, as the pressing pin 111 presses the paper S by narrowing the displacement of elevating member 112 with respect to the second direction, a folding line in the second direction can be formed as it is formed by the second folding line forming apparatus 120. Of course, such a method takes more time than forming the folding line in the second direction across the entire width of the paper S by using the elevating plate 122 of the second folding line forming apparatus 120. However, it is an advantage that an additional second folding line forming apparatus 120 is not needed so that a compact image output apparatus is possible.

As described above, in the image output apparatus according to the present invention, since a user selects a desired pattern of a folding line and the first and second folding line forming apparatuses are selectively driven, a folding line corresponding to the input pattern can be formed in the first and second directions.

The above-described image output apparatus according to the present invention has the following advantages. First, since a desired folding line pattern is formed on an outputted paper, a user can conveniently fold the paper into a desired shape. Second, since the folding lines can be formed both in the first direction (parallel to the direction in which the paper is transferred) and in the second direction (perpendicular thereto), a variety of folding line patterns can be realized.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An image output apparatus to print an image on a sheet of paper and to output the printed paper while transferring the paper along a paper transfer path, the apparatus comprising:
a first folding line forming apparatus to form a first folding line in a first direction parallel to a direction in which the paper is transferred along the paper transfer path; and
a second folding line forming apparatus to form a second folding line, in a second direction perpendicular to the first direction, wherein the first and second folding line forming apparatuses are provided along the paper transfer path.

2. The apparatus of claim 1, wherein the first folding line forming apparatus comprises:
an elevating member installed opposite the paper transfer path;
an actuator to move the elevating member away from the paper transfer path; and
a pressing pin installed at the elevating member to press the paper disposed thereunder to form the first folding line in the first direction.

3. The apparatus of claim 2, wherein the first folding line forming apparatus further comprises a transfer unit to move the elevating member in the second direction.

4. The apparatus of claim 3, wherein the transfer unit comprises:
a guide rail installed to extend in the second direction;
a moving block installed to move along the guide rail, the elevating member being mounted on the moving block; and
a driving apparatus to move the moving block along the guide rail to a desired position.

5. The apparatus of claim 4, wherein the first folding line forming apparatus forms a third folding line, in the second direction, by moving the elevating member away from the paper transfer path while moving the moving block in the second direction.

6. The apparatus of claim 2, wherein the first folding line forming apparatus further comprises a support pad opposite to the elevating member with respect to the paper and to receive a pressing force from the pressing pin.

7. The apparatus of claim 1, wherein the second folding line forming apparatus comprises:
an elevating plate having a width in the second direction corresponding to a width of the paper in the second direction and installed to be moved to/away from the paper transfer path;
an actuator to elevate the elevating plate; and
a pressing pin installed at the elevating plate to form the second folding by pressing the paper disposed thereunder.

8. The apparatus of claim 7, wherein the second folding line forming apparatus further comprises a support pad installed at a position corresponding to the elevating plate with respect to the paper and to receive a pressing force of the pressing pin.

9. A method of forming a paper folding line of an image output apparatus comprising:
providing a first folding line forming apparatus to form a first folding line in a first direction parallel to a direction in which a sheet of paper is transferred along a paper transfer path, and a second folding line forming apparatus to form a second folding line in a second direction perpendicular to the first direction, wherein the first and second folding line forming apparatuses are provided on the paper transfer path;
inputting a folding line pattern to be formed on the paper in the first and second directions; and
forming the first and second folding lines by selectively driving the first and second folding line forming apparatuses according to the input folding line pattern.

10. The method of claim 10, wherein the inputting comprises:
providing a plurality of predetermined folding line patterns through an information processor connected to the image output apparatus;
providing an arbitrary setting environment through the information processor to set a folding line pattern different from the predetermined folding line patterns; and
inputting the set folding pattern.

11. An apparatus to process a paper, the apparatus comprising:
a first unit to form a first folding line on the paper in a first direction; and
a second unit to form a second folding line on the paper in a second direction different from the first direction.

12. The apparatus of claim 11, wherein the first direction is perpendicular to the second direction.

13. The apparatus of claim 11, wherein the paper is transferred along a paper transfer path, and the first direction is parallel to the paper transfer path.

14. The apparatus of claim 13, wherein the first and second units are provided along the paper transfer path.

15. The apparatus of claim 11, wherein the second unit forms a third line, the third line being in the second direction.

16. The apparatus of claim 11, wherein the first folding line has a width less than a width of the paper in the first direction.

17. A method of processing a paper, comprising:
moving a first member having a first pin to/from the paper to form a first folding line thereon;
moving the paper to a second member having a second pin; and
moving the second member to/from the paper to form a second folding line thereon.

18. The method of claim 17, further comprising:
moving the paper when the first member is moving to/from the paper; and
stopping the paper when the second member is moving to/from the paper.

19. The method of claim 17, wherein the moving of the first member comprises moving the first member from a first position with respect to the paper to a second position with respect to the paper, and the moving of the paper comprises moving the paper so that the second member moves from the second position to a third position with respect to the paper.

20. An apparatus to print an image on a paper, the apparatus comprising:
a unit to form a first folding line on the paper in a first direction, and a second folding line in a second direction, the apparatus comprising:
a member to move to/away from the paper, and a pin, attached to the member, to press the paper during the movement of the member to the paper, to form the first and second folding lines.
